(19) United States
(12) Patent Application Publication
(10) Pub. No.: US 2023/0406741 A1
(43) Pub. Date: Dec. 21, 2023

(54) SYSTEM AND METHOD FOR AUTO-FLOCCULATION OF WASTEWATER

(71) Applicant: University of Massachusetts, Boston, MA (US)

(72) Inventors: Chul Park, Amherst, MA (US); Ahmed S. Abouhend, Amherst, MA (US); Joseph G. Gikonyo, Belchertown, MA (US)

(21) Appl. No.: 18/337,953

(22) Filed: Jun. 20, 2023

Related U.S. Application Data
(60) Provisional application No. 63/366,751, filed on Jun. 21, 2022.

(51) Int. Cl. C02F 3/12; B01F 27/90; C02F 1/30

(52) U.S. Cl. CPC C02F 3/1284; B01F 2101/305; C02F 1/30; B01F 27/90

(57) ABSTRACT

A method comprises the steps of receiving a wastewater containing solid particles in suspension, agitating the wastewater for a specified agitation period under specified agitation conditions sufficient to enable auto-flocculation of at least a portion of the solid particles into flocs to provide an agitated wastewater, allowing the agitated wastewater to settle for a specified sedimentation period to allow at least a portion of the flocs to settle, and separating at least a portion of the settled flocs from the agitated wastewater to provide a clarified wastewater effluent.

### CROSS-REFERENCE TO RELATED APPLICATION

This application claims priority under 35 U.S.C. § 119(e) to U.S. Provisional Application Ser. No. 63/366,751, filed on Jun. 21, 2022, entitled “SYSTEM AND METHOD FOR AUTO-FLOCCULATION OF WASTEWATER,” the disclosure of which is incorporated herein by reference in its entirety.

### STATEMENT OF GOVERNMENT SUPPORT

This invention was made with Government support under grant number TI-1919091 awarded by the National Science Foundation (NSF). The U.S. Government has certain rights in this invention.

### BACKGROUND

One aspect of wastewater treatment that can be challenging is the separation of sediment and other small particles from the wastewater. Only about half of the total suspended solids (TSS) and biochemical oxygen demand (BOD), also referred to as the “primary pollutants” or “conventional pollutants” of the wastewater, are removed by a typical sedimentation process. This means that as much as 50% or more of the contaminants still remain in the settled wastewater.

Treatment of settled wastewater via activated sludge is generally fast and effective, but requires a large amount of energy, in particular to aerate the wastewater in order to dissolve oxygen gas (O2). It is typical in the United States for wastewater treatment takes up as much as one-third of the total energy usage for many municipalities. Wastewater treatment using waste stabilization ponds (WSPs) can be less costly, but is substantially slower. WSP treatment can take several days or weeks compared to several hours for activated sludge processes. This passive and slow nature of treatment is why WSPs require large land areas.

Adding chemical treatment to promote flocculation, such as with chemical coagulants or flocculants, has been tried to enhance sedimentation-based wastewater treatment. However, chemical additives are less desirable and less sustainable because of the need for large amounts of chemical supplies. In addition, the addition of chemical additives such as coagulants or flocculants results in the formation of waste sludge with increased toxicity.

In addition, in both activated sludge and WSP processes, some carbon-rich organic matter can degrade into carbon dioxide (CO₂), which then enters the atmosphere as greenhouse gas emissions.

### SUMMARY

The present disclosure describes systems and methods for controlled handling of wastewater without adding aggregation-enhancing additives such as chemical coagulant or chemical flocculant. In particular, the present disclosure describes systems and methods for controlled agitation of the wastewater in a way that results in surprising and unexpected levels of flocculation within the wastewater. The increased flocculation under the controlled agitation conditions can provide for substantially shorter sedimentation times for wastewater treatment, which can have several advantages, as discussed below.

### BRIEF DESCRIPTION OF THE DRAWINGS

FIG. 1 is a schematic diagram of an example of a conventional system for treatment of a wastewater stream to remove suspended solids.

FIG. 2 is a schematic diagram of another example of conventional system for treatment of a wastewater to remove suspended solids.

FIG. 3 is a schematic diagram of an example system for treatment of a wastewater stream to remove suspended solids, in accordance with the present disclosure.

FIG. 4 is a schematic diagram of another example system for treatment of a wastewater stream to remove suspended solids, in accordance with the present disclosure.

FIG. 5 is a schematic diagram of a third example system for treatment of a wastewater stream to remove suspended solids, in accordance with the present disclosure.

FIGS. 6A and 6B are photographs of wastewater samples treated by conventional settling in a primary clarifier and treated with a controlled agitation and sedimentation method in accordance with the present disclosure, respectively.

FIGS. 7A-7D are micrograph images of auto-flocs formed by the controlled agitation and sedimentation method in accordance with the present disclosure.

FIG. 8 is a bar graph showing the total suspended solids of COMPARATIVE EXAMPLE 1, which was treated by conventional treatment in a primary clarifier, and of EXAMPLES 2 and 3, which were treated by the controlled agitation and sedimentation method of the present disclosure.

FIG. 9 is a graph of total suspended solids removal for various mixing speeds in the controlled agitation and sedimentation method of the present disclosure.

FIG. 10 is a graph of total suspended solids (“TSS”) achieved for various speeds of mixing wastewater in COMPARATIVE EXAMPLE 1 and EXAMPLES 12-19.

FIG. 11 is a graph of TSS achieved for various shear rates applied to the wastewater in COMPARATIVE EXAMPLE 20 and EXAMPLES 21-27.

FIG. 12 is a graph of the TSS content achieved versus the product of shear rate (G) and agitation period (t) (referred to as “Gt”) for the wastewater of COMPARATIVE EXAMPLE 20 and EXAMPLES 21-27.

FIG. 13 is a graph of the TSS achieved for various shear rates applied to the wastewater of COMPARATIVE EXAMPLE 28 and EXAMPLES 29-35.

FIG. 14 is a graph of the TSS content achieved versus the product of shear rate and agitation period (Gt) for the wastewater of COMPARATIVE EXAMPLE 28 and EXAMPLES 29-35.

FIG. 15 is a graph showing the effect of illumination under specified illumination conditions during the controlled agitation and sedimentation method of the present disclosure.

### DETAILED DESCRIPTION

The present disclosure describes systems and methods for enhanced separation of solids from wastewater as part of primary treatment of the wastewater. The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range. The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.”

In methods described herein, steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The systems and methods described herein provide for auto-flocculation of wastewater during a wastewater treatment process. As used herein, the term “auto-flocculation”refers to flocculation or other aggregation of suspended solids particles that are present in the wastewater without the use of chemical coagulants, chemical flocculants, or other aggregation-enhancing compounds, such as iron or aluminum salts or organic polymers.

The systems and methods described herein are particularly suited for the primary treatment/separation phase of the wastewater treatment process. As used herein, the phrases “primary treatment” “or “primary separation” refers to the phase of the wastewater treatment process where more easily separated material is separated from the liquid medium of the wastewater before subjecting the resulting settled wastewater to secondary treatment, which is the phase of the wastewater treatment process that involves the use of biological processing of the settled wastewater, e.g., using bacteria and other microbes to consume organic material within the settled wastewater in order to reduce the overall biochemical oxygen demand (BOD) of the wastewater. As described in more detail below, the systems and methods described herein involve enhanced auto-flocculation of suspended solids within the wastewater as part of the primary separation.

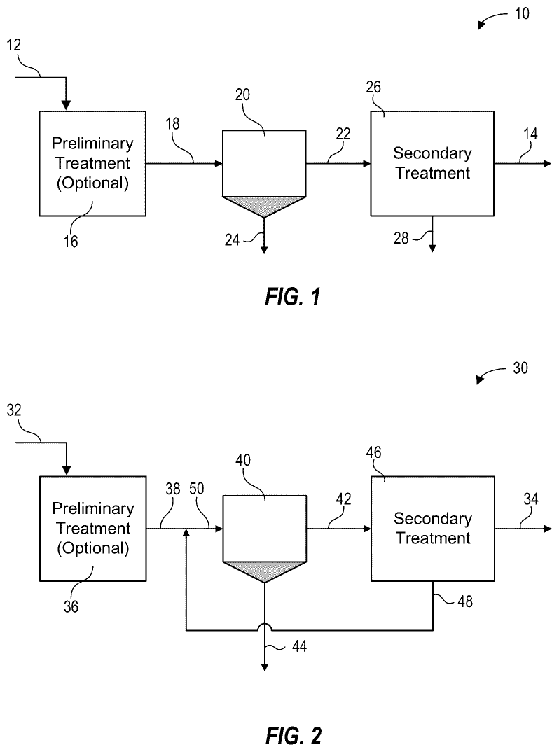

FIG. 1 is a basic schematic diagram of a conventional system 10 for the treatment of raw wastewater 12 to provide a treated effluent 14. As will be appreciated by those with skill in the art, the raw wastewater 12 comprises a water-based reaction medium with organic matter suspended or dissolved therein. In an example, the raw wastewater 12 includes suspended particles of organic material (e.g., proteins, carbohydrates, oils, grease, and other organic compounds) and inorganic material (e.g., grit such as sand or gravel), dissolved organic material, and other dissolved or suspended material. Microorganisms, such as algae, cyanobacteria, bacteria, and protozoa, can also be present in the raw wastewater 12. The microorganisms can be present as part of an activated sludge that is present in the raw wastewater 12, especially in the raw wastewater that includes wastewater, treated effluents, or waste sludges discharged from other wastewater treatment works or industries as part of pretreatment. As used herein, the term “activated sludge” refers to a mixed liquor, a thickened mixed liquor, or biofilm present and used in water and wastewater treatment systems. Activated sludge is also sometimes referred to as “sewage sludge,” “returned activated sludge,” and “waste activated sludge.” In an example, the activated sludge in the wastewater 14 is the inoculum source of various microorganisms that can be useful in later phases of the wastewater treatment system 10.

In an example, the raw wastewater 12 is subjected to one or more optional preliminary treatment operations 16 that are designed to remove material that floats in the raw wastewater 12 or that will readily settle out from the liquid medium of the raw wastewater 12. Examples of preliminary treatment operations 16 include, but are not limited to: (a) screens or filtration devices for filtering out large debris such as wood, rags, or other bulky objects that might otherwise block pipes, pumps, or other equipment in the system 10; (b) a comminutor or other grinding device to grind or shred larger more easily broken down material (such as paper, wood, cloth, etc.); and (c) a grit chamber or grit settler to settle heavier solids such as sand, gravel, coffee grounds, eggshells, and the like out of the raw wastewater 12. The one or more preliminary treatment operations 16 result in a partially clarified wastewater 18 where most of the larger and more easily separated material has been removed or broken down. In an example, the partially clarified wastewater 18 has a total suspended solids (TSS) content of at least about 120 milligrams of suspended solids per liter (mg/L), for example at least about 150 mg/L, such as at least about 175 mg/L, for example at least about 200 mg/L. As shown in the specific EXAMPLES below, in specific examples of raw wastewater from a municipal wastewater treatment facility, the partially clarified wastewater 18 can have a TSS content of from about 200 mg/L to about 230 mg/L, such as about 203 mg/L, about 218 mg/L, and about 228 mg/L.

In an example, the partially clarified wastewater 18 can be fed into a primary clarifier 20, which uses gravity settling to separate suspended solids from the partially clarified wastewater 18 to provide a clarified settled water stream 22 and a primary sludge 24. In examples where there are no preliminary treatment operations 16, the raw wastewater 12 can be fed directly into the primary clarifier 20 such that the primary clarifier 20 separates the raw wastewater 12 into the primary sludge 24 and the settled water 22. In an example, the primary clarifier 20 is a vessel that is configured so that the raw wastewater 12 or the partially clarified wastewater 18 will have a relatively long retention time within the primary clarifier 20, e.g., about 2 hours of sedimentation time, so that suspended solids particles settle to the bottom of the tank of the primary clarifier 20 where the settled particles are removed as a primary sludge 24. In an example, the primary clarifier 20 can provide for sedimentation of about half (50%) to about 70% of the TSS that had been present in the raw wastewater 12 or the partially clarified wastewater 18, e.g., so that the TSS of the settled water 22 is from about 50 mg/L to about 100 mg/L, such as from about 60 mg/L to about 75 mg/L. As shown in the specific EXAMPLES below, in a specific example where the raw wastewater 12 has a TSS of about 218 mg/L, the primary clarifier 20 is able to provide a settled water 22 with a TSS of about 65 mg/L.

The settled water 22 from the primary clarifier 20 is then fed into a secondary treatment process 26 to remove additional organic matter that was not captured and separated by the preliminary treatment operations 16 and/or the primary clarifier 20. In particular, the secondary treatment process 26 can be configured to remove soluble organic matter that is dissolved within the settled water 22 via a biological process where microbes such as bacteria or cyanobacteria consume the soluble organic matter and convert it to energy for their own growth and reproduction and give off carbon dioxide (CO₂) and water (H₂O). The secondary treatment process 26 can remove a secondary sludge 28 and the dissolved organic matter from the settled water 22 to produce the treated effluent 14. The secondary sludge 28, which is also sometimes referred to as waste activated sludge 28, can include additional suspended solids material that had not been captured by the preliminary treatment operations 16 or the primary clarifier 20 and other solid material that results from the biological processes of the secondary treatment process 26.

As discussed above, two of the most common types of the secondary treatment process 26 are the activated sludge process, which are more common in high-income countries and municipalities, and the waste stabilization pond (WSP) process, which are more common in low or mid-income countries, regions, and municipalities. However, the present disclosure is not limited to an activated sludge process, a WSP process, or to any other secondary treatment process. Another example of a secondary treatment process 26 is an algae-based treatment process. Specifics of activated sludge processes, WSP processes, algae-based processes, and other secondary treatment methods are well-known by those having skill in the art and will not be described herein. As will be appreciated by those of skill in the art, in some examples of WSP processes, there are not preliminary treatment operations 16 and/or no primary clarifier 20, but rather the raw wastewater 12 is fed directly into a series of WSPs (such as one or more anaerobic lagoons, one or more facultative ponds, and one or more maturation ponds), which use various biological processes to slowly remove organic matter from the raw wastewater 12.

FIG. 2 is a basic schematic diagram of another conventional system 30 for the treatment of raw wastewater 32 to provide a treated effluent 34. The system 30 of FIG. 2 is largely the same as the example system 10 discussed above with respect to FIG. 1. For example, in the system 30, the raw wastewater 32 (which can be similar or identical to the raw wastewater 12 described above) can be fed into one or more optional preliminary treatment operations 36 to remove larger-sized particles and provide a partially clarified wastewater 38. The one or more preliminary treatment operations 36 can be similar or identical to the preliminary treatment operations 16 described above. The partially clarified wastewater 38 can be fed into a primary clarifier 40 (which can be similar or identical to the primary clarifier 20 described above) to separate suspended solids from the partially clarified wastewater 38 to provide a clarified settled water stream 42 and a primary sludge 44. The settled water 42 can then be fed into a secondary treatment process 46 (which can be similar or identical to the secondary treatment process 26 described above) to remove additional organic matter not captured by the one or more preliminary treatment operations 36 and/or the primary clarifier 40 to remove a secondary sludge or waste activated sludge 48 from the settled water 42 to produce the treated effluent 34.

The primary difference between the system 10 of FIG. 1 and the system 30 of FIG. 2 is that the secondary sludge or waste activated sludge 48 is recycled back to the primary clarifier 40 to enhance primary clarification of the raw wastewater 32 or the effluent from the one or more preliminary treatment operations 36, i.e., the partially clarified wastewater 38, and further thickening of the secondary sludge or the waste activated sludge 48. In this practice, the raw wastewater 32 or the partially clarified wastewater 38 is combined with the secondary sludge or the waste activated sludge 48 to provide a wastewater and sludge blend 50, which is subjected to clarification in the primary clarifier 40, which provides the clarified water 42 and the settled sludge 44 (which is a mixture of primary sludge settled from the raw wastewater 32 or the partially clarified wastewater 38 and the secondary sludge 48 from the secondary treatment process 46). As described above, the clarified water 42 is further processed by the secondary treatment process 46 that generates the secondary sludge or the waste activated sludge 48.

As mentioned above, the inventors have discovered that controlled agitation under specified agitation conditions without the use of chemical coagulants, chemical flocculants, or other aggregation-enhancing additives can result in better aggregation of suspended solids in the raw wastewater 12, 32, the partially clarified wastewater 18, 38, or the settled water 22, 42 compared to what is capable by only using the conventional preliminary treatment operations 16 and clarification with the primary clarifier 20, as in system 10, or the conventional preliminary treatment operations 36 and clarification of the raw wastewater 32 or the blend 50 of the partially clarified wastewater 38 and the secondary sludge or the waste activated sludge 48, as in the system 30. This enhanced aggregation can result in the removal of more suspended solids than are capable of being removed by Dconventional separation (e.g., in the preliminary treatment operations 16, 36 and/or the primary clarifier 20, 40 in the systems 10 and 30 of FIGS. 1 and 2). In particular, the inventors recognized that municipal wastewater, e.g., the type that is typical for the raw wastewater 12, 32 in the systems 10 and 30, has the potential for self-flocculation (also referred to herein as “auto-flocculation”) when the wastewater is mixed or otherwise agitated under specified shear conditions.

This auto-flocculation ability is currently unrealized by current methods of handling, conveyance, and sedimentation in conventional wastewater treatment processes such as the systems 10 and 30 shown in FIGS. 1 and 2. As such, conventional wastewater treatment systems and methods can result in substantial amounts of unsettled TSS and BOD breaking through the preliminary treatment operations 16, 36 and the primary clarifier 20, 40 and being present in the settled water 22, 42 that is to be fed to the secondary treatment process 26, 46.

By providing for enhanced aggregation and separation of additional suspended solids from the settled water that will be fed into the secondary treatment process, the systems and methods described herein can provide for higher overall efficiency in removal of TSS and BOD, which can have several advantages, including, but not necessarily limited to: a substantial reduction in aeration needed in activated sludge treatment (because there is less suspended solids and BOD to be removed during aeration, which in turn results in a substantial reduction in energy needed for activated sludge processes); a substantial reduction in the time and land area needed for waste stabilization pond (WSP) treatment (because there is less suspended solids and less organic matter that has to be removed by the WSP); a decrease in CO₂ release for both activated sludge and WSP processes (because there is less organic matter being fed into the secondary treatment process to act as food for the microorganisms in the biological process of the secondary treatment process); and the recovery of more carbon from the wastewater for anaerobic digestion or other bioenergy recovery processes.

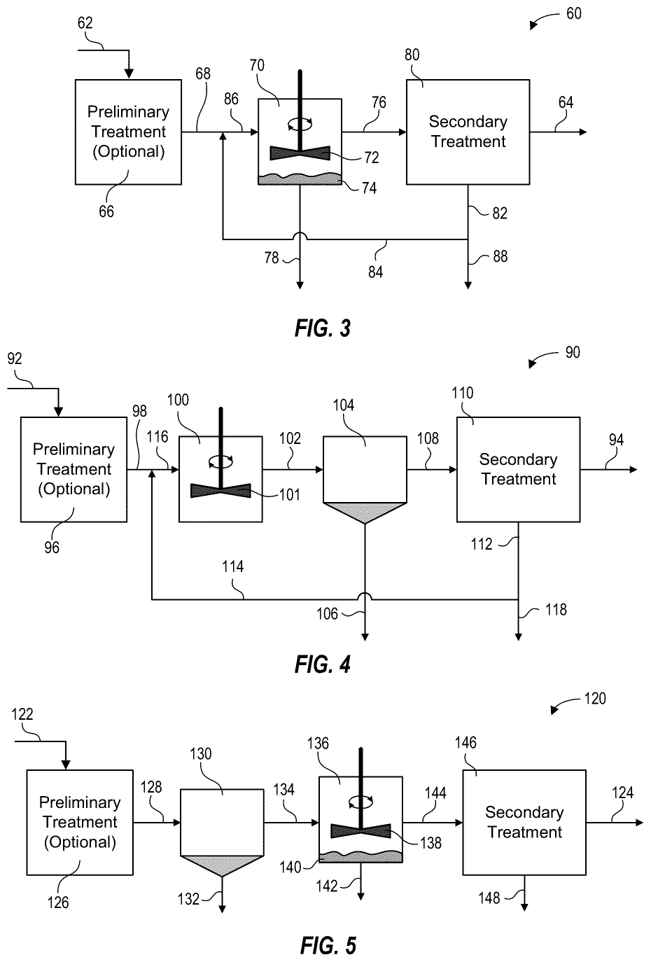

FIGS. 3-5 show various examples of systems that provide for enhanced aggregation and separation of suspended solids from various streams in a wastewater treatment process, in accordance with the present disclosure. FIG. 3 is a schematic diagram of an example system 60 for the treatment of raw wastewater 62 to provide a treated effluent 64. The system 60 is similar to the systems 10 and 30 of FIGS. 1 and 2. For example, the raw wastewater 62 includes suspended particles of organic material, inorganic material, dissolved organic material, other dissolved or suspended material, and may also include microorganisms, such as algae, cyanobacteria, bacteria, and protozoa.

In an example, the raw wastewater 62 is subjected to one or more optional preliminary treatment operations 66, which can be similar or identical to the preliminary treatment operations 16 and 36 described above with respect to FIGS. 1 and 2, and which can provide a partially clarified wastewater 68. While it is not required, in some examples, a portion 84 of a secondary sludge or waste activated sludge 82 from a secondary treatment process 80 can be blended with the partially clarified wastewater 68 to provide a blend 86 to increase the solids concentration compared to the raw wastewater 62 or the partially clarified wastewater 68 by itself. The inventors have found that this can promote auto-flocculation to occur under the specified agitation conditions (described below).

The system 60 can include a mixing vessel 70 that provides for controlled mixing and sedimentation of the partially clarified wastewater 68. In an example where there are no preliminary treatment operations 66, the raw wastewater 62 or the blend 86 with the secondary sludge or waste activated sludge 84 can be fed directly into the mixing vessel 70 where the specified agitation and sedimentation of the raw wastewater 62, the partially clarified wastewater 68, or the wastewater-sludge blend 86 can occur.

The mixing vessel 70 is configured to agitate the raw wastewater 62, the partially clarified wastewater 68, or the wastewater-sludge blend 86, with a mixing unit 72 (e.g., an impeller 72), under a specified shear for a specified agitation period, followed by a specified sedimentation period (e.g., where agitation is ceased, such as by turning off the impeller 72, so as to allow suspended solids to settle to the bottom of the mixing vessel 70 as sediment 74). As described in more detail below, the specified agitation (e.g., at the specified shear force, specified shear rate, and/or specified mixing speed) causes at least a portion of the suspended solid particles in the raw wastewater 62, the partially clarified wastewater 68, or the wastewater-sludge blend 86 to auto-flocculate into flocs (also referred to herein as “auto-flocs”) that more readily settle from the liquid and are easier to separate. Periodically, e.g., after one or more batches of controlled mixing and sedimentation by the mixing vessel 70, the sediment 74 can be removed from the mixing vessel 70 as a settled sludge 78.

In the example shown in FIG. 3, the mixing vessel 70 in which the controlled agitation of the raw wastewater 62, the partially clarified wastewater 68, or the wastewater-sludge blend 86 is performed is a mixing tank-type vessel, e.g., with a specified tank volume in which an impeller 72 mixes the raw wastewater 62, the partially clarified wastewater 68, or the wastewater-sludge blend 86 under the specified shear conditions. However, those having skill in the art will appreciate that the mixing vessel 70 in which the specified agitation takes place can be other types of vessels, including, but not limited to: a channel through which the raw wastewater 62, the partially clarified wastewater 68, or the wastewater-sludge blend 86 flows, such as a ditch or a trough; a pipe through which the raw wastewater 62, the partially clarified wastewater 68, or the wastewater-sludge blend 86 flows; a feedwell from which the agitated raw wastewater 62, partially clarified wastewater 68, or the wastewater-sludge blend 86 is distributed; or a clarifier from which the agitated raw wastewater 62, partially clarified wastewater 68, or the wastewater-sludge blend 86 is distributed.

In the example shown in FIG. 3, the mixing unit 72 is a mechanical impeller 72 that is rotated or moved through the raw wastewater 62, the partially clarified wastewater 68, or the wastewater-sludge blend 86 to agitate the fluid with the specified shear. Those having skill in the art will appreciate that other mixing devices can be used to provide the specified agitation of the raw wastewater 62, the partially clarified wastewater 68, or the wastewater-sludge blend 86 such as a static inline mixer to mix the raw wastewater 62, the partially clarified wastewater 68, or the wastewater-sludge blend 86 in a pipeline through which the fluid is flowing.

In an example, the agitation of the wastewater (e.g., the raw wastewater 62, the partially clarified wastewater 68, or the wastewater-sludge blend 86) can be performed as part of a continuous or substantially continuous flow process, e.g., with the wastewater flowing continuously or substantially continuously through the mixing vessel 70 while the specified agitation conditions (e.g., one or more of the specified shear force, the specified shear rate, or the specified mixing speed) are applied to the raw wastewater 62, the partially clarified wastewater 68, or the wastewater-sludge blend 86.

In the example shown in FIG. 3, the sedimentation of the agitated raw wastewater 62, the agitated partially clarified wastewater 68, or the agitated wastewater-sludge blend 86 occurs in the same vessel in which the controlled agitation occurs, i.e., within the mixing vessel 70. However, those having skill in the art will appreciate that the sedimentation can occur in another vessel, such as within a subsequent clarifier or settling tank positioned downstream of the mixing vessel 70 (as shown in the example of FIG. 4).

In an example, the specified shear that is imparted on the raw wastewater 62, the partially clarified wastewater 68, or the wastewater-sludge blend 86 in the mixing vessel 70 is defined as a specified shear force exerted by the mixing unit 72 onto the raw wastewater 62, the partially clarified wastewater 68, or the wastewater-sludge blend 86. In an example, the specified shear force is from about 0.0005 Newtons per square meter (N/m²) to about 0.05 N/m², such as from about 0.001 N/m² to about 0.045 N/m², for example from about 0.002 N/m² to about 0.04 N/m², such as from about 0.003 N/m² to about 0.035 N/m², for example from about 0.004 N/m² to about 0.03 N/m², such as from about 0.005 N/m² to about 0.025 N/m², for example from about 0.006 N/m² to about 0.02 N/m², such as from about 0.007 N/m² to about 0.015 N/m², for example from about 0.008 N/m² to about 0.01 N/m². In another example, the specified shear that is imparted onto the raw wastewater 62, the partially clarified wastewater 68, or the wastewater-sludge blend 86 in the mixing vessel 70 is defined as a specified shear rate exerted by the mixing unit 72. In an example, the specified shear rate is from about 0.5 reciprocal seconds (s⁻¹) to about 50 s⁻¹, such as from about 1 s⁻¹ to about 45 s⁻¹, for example from about 2 s⁻¹ to about 40 s⁻¹, such as from about 3 s⁻¹ to about 35 s⁻¹, for example from about 4 s⁻¹ to about 30 s⁻¹, such as from about 5 s⁻¹ to about 25 s⁻¹, for example from about 10 s⁻¹ to about 20 s⁻¹. In another example, the specified shear can be defined as a specified mixing speed of the impeller 72, e.g., a specified number of rotations per minute by the impeller 72. In an example, the specified mixing speed can be from about 5 rotations per minute (5 rpm) to about 100 rpm, such as from about 10 rpm to about 75 rpm, for example from about 15 rpm to about 50 rpm, such as from about 20 rpm to about 40 rpm, for example one or any range between about 5 rpm, about 7.5 rpm, about 10 rpm, about 12.5 rpm, about rpm, about 17.5 rpm, about 20 rpm, about 22.5 rpm, about 25 rpm, about 27.5 rpm, about rpm, about 32.5 rpm, about 35 rpm, about 37.5 rpm, about 40 rpm, about 42.5 rpm, about rpm, about 47.5 rpm, about 50 rpm, about 52.5 rpm, about 55 rpm, about 57.5 rpm, about rpm, about 62.5 rpm, about 65 rpm, about 67.5 rpm, about 70 rpm, about 72.5 rpm, about rpm, about 77.5 rpm, about 80 rpm, about 82.5 rpm, about 85 rpm, about 87.5 rpm, about rpm, about 92.5 rpm, about 95 rpm, about 97.5 rpm, or about 100 rpm.

In an example, the raw wastewater 62, the partially clarified wastewater 68, or the wastewater-sludge blend 86 is subjected to the specified agitation conditions (e.g., the specified shear force, specified shear rate, and/or specified mixing speed) for a specified agitation period of from about 0.1 second to about 120 minutes (min), such as from about 1 sec to about 30 sec, or from about 1 min to about 3 min, or from about 5 min to about 90 min, for example from about 10 min to about 60 min, such as from about 15 min to about 45 min, for example from about 20 min to about 35 min, for example one or any range between about 0.1 s, about 1 s, about 5 s, about 10 s, about 15 s, about 20 s, about 25 s, about 30 s, about 35 s, about 40 s, about 45 s, about 50 s, about 55 s, about 1 min, about 1.5 min, about 2 min, about 2.5 min, about 5 min, about 7.5 min, about 10 min, about 12.5 min, about 15 min, about 17.5 min, about 20 min, about 22.5 min, about 25 min, about 27.5 min, about 30 min, about 32.5 min, about 35 min, about 37.5 min, about 40 min, about 42.5 min, about 45 min, about 47.5 min, about 50 min, about 55 min, about 60 min, about 65 min, about 70 min, about 75 min, about 80 min, about 85 min, about 90 min, about 95 min, about 100 min, about 105 min, about 110 min, about 115 min, about 120 min.

The specified shear conditions can be controlled to provide for a specified level of auto-flocculation. In other words, the intensity of mixing in the mixing vessel 70 (and therefore the resulting shear force that is exerted onto the raw wastewater 62, the partially clarified wastewater 68, or the wastewater-sludge blend 86) can be adjusted based on one or more properties of the wastewater 62, 68, 86 during the agitation and auto-flocculation. Examples of properties upon which the agitation intensity can be based include, but are not limited to: a TSS value in the wastewater 62, 68, 86 at a particular point in time during the controlled agitation; or a turbidity of the wastewater 62, 68, 86 at a particular point in time during the controlled agitation. In an example, the agitation intensity can be manually controlled by an operator during the agitation of the wastewater 62, 68, 86 by the mixing vessel 70. In another example, the agitation intensity can be automatically controlled as part of a process control system. For example, the system 60 can include one or more sensors for measuring TSS and/or turbidity of the wastewater 62, 68, 86 entering the mixing vessel 70 or within an interior of the mixing vessel 70. The agitation intensity (e.g., the mixing speed of the impeller 72) can be set based on the measured TSS and/or turbidity measured by one or more sensors. In an example, if the measured TSS and/or turbidity is higher than a specified set point, then the agitation intensity in the mixing vessel 70 can be increased, e.g., so that the shear force exerted on the wastewater 62, 68, 86 in the mixing vessel 70 is increased in order to increase activation of the auto-flocculation. In contrast, if the measured TSS and/or turbidity of the wastewater 62, 68, 86 is below a specified set point, then the agitation intensity can be reduced to enhance auto-flocculation of the wastewater 62, 68, 86.

After the raw wastewater 62, the partially clarified wastewater 68, or the wastewater-sludge blend 86 is subjected to the controlled specified agitation conditions (e.g., the specified shear force, specified shear rate, and/or specified mixing speed) for the specified agitation period, the inventors have found that allowing the agitated wastewater 62, 68, or 86 to settle for a specified sedimentation period where the agitation is ceased activates the auto-flocculation capability of the wastewater 62, 68, or 86 so that a substantial portion of the suspended solids within the wastewater 62, 68, or 86 will settle out of suspension as the sediment 74 to provide a settled water effluent 76. In an example, the specified sedimentation period is from about 1 min to about 30 minutes, for example from about 3 min to about 20 min, such as from about 5 min to about 15 min.

The inventors have found that the specified agitation and sedimentation described above can provide for a substantially higher amount of suspended solid removal from the raw wastewater 62 or the partially clarified wastewater 68 compared to conventional methods of primary solids removal. For example, as shown in a specific EXAMPLE below, in an example where the partially clarified wastewater 68 has a TSS of about 218 mg/L (e.g., the same as described above for the conventional system 10 in FIG. 1) and where the preliminary treatment operations 66 in the system 60 are identical to the preliminary treatment operations 16 of the system 10, agitation of the partially clarified wastewater 68 at 40 rpm (corresponding to a shear force of about 0.0145 N/m²) for 20 min followed by 5 min of sedimentation time resulted in the settled water 76 having a TSS content that was about 30 mg/L, or less than half as much TSS as the settled water 22 coming out of the primary clarifier 20 in the conventional system 10 (which was about 65 mg/L). For another example, as shown in a specific EXAMPLE below, the partially clarified wastewater 68 has a TSS of about 228 mg/L, 30 seconds of agitation of the wastewater-sludge blend 86 (formed by mixing together the partially clarified wastewater 68 and the secondary sludge or waste activated sludge 84) at varying speeds for the specified shear conditions followed by 30 minutes of sedimentation resulted in the settled water effluent 76 having a TSS content of from about 19 mg/L to about 34 mg/L, which is significantly less than the TSS content of the settled water 22 coming out of the primary clarifier 20 in the conventional system 10 of FIG. 1 (which was found to be about 61 mg/L) and the TSS content of the settled water 42 coming out of the primary clarifier 40 in the alternative conventional system 30 of FIG. 2 (which was found to be about 54 mg/L). For another example, as shown in a specific EXAMPLE below, where the partially clarified wastewater 68 had a TSS of about 203 mg/L, 60 seconds of agitation of the wastewater-sludge blend 86 (formed by mixing the partially clarified wastewater 68 and the secondary sludge or waste activated sludge 84) at varying speeds for the specified shear conditions followed by 30 minutes of sedimentation resulted in the settled water 76 having a TSS content that is from about 33 mg/L to about 53 mg/L, which was less than the TSS content of the settled water 22 coming out of the primary clarifier 20 in the conventional system 10 of FIG. 1 (which was about 58 mg/L) and the TSS content of the settled water 42 coming out of the primary clarifier 40 in the alternative conventional system of FIG. 2 (which was about 56 mg/L).

After the sediment 74 has been allowed to settle to the bottom of the mixing vessel 70, the remaining settled water 76 can be removed from the mixing vessel 70 and fed into the secondary treatment process 80, which produces the secondary sludge 82 that is separated from the treated effluent 64. While this secondary sludge 82 is conventionally removed as a waste sludge stream 88 after secondary clarification (not shown in figures), as discussed above, in an example, at least a portion 84 of the secondary sludge or waste activated sludge 82 to blend with the wastewater 62, 68 to provide the wastewater-sludge blend 86 with enhanced solids concentration and to promote auto-flocculation by the specified agitation conditions. The secondary treatment process 80 can be similar or identical to the secondary treatment processes 26 and 46 described above with respect to FIGS. 1 and 2 (e.g., the secondary treatment process 80 can be an activated sludge process, a WSP process, or an algae-based process for removal of additional organic matter that was not captured by the preliminary treatment operations 66 and/or the controlled agitation and sedimentation of the mixing vessel 70).

In an example where the recycled waste activated sludge 84 is mixed with the raw wastewater 62 or the partially clarified wastewater 68 to from the wastewater-sludge blend 86 for specified agitation in the mixing vessel 70, such as in the system 60 shown in FIG. 3, the TSS concentration of the wastewater-sludge blend 86 can be from about 250 mg/L to about 1500 mg/L, which has been found to promote auto-flocculation. Further details are provided in the EXAMPLES below.

FIG. 4 is a schematic diagram of another example system 90 for the treatment of raw wastewater 92 to provide a treated effluent 94. The example system 90 of FIG. 4 is similar to the system 60 of FIG. 3, but with an additional unit operation. For example, the system 90 can include one or more optional preliminary treatment operations 96 into which can be fed the raw wastewater 92 for initial separation of easier-to-separate solids from the raw wastewater 92 to provide a partially clarified wastewater 98. The preliminary treatment operations 96 can be similar or identical to those described above for the preliminary treatment operations 16, 36 in the systems 10 and 30 of FIGS. 1 and 2.

Similar to the system 60 of FIG. 3, the system 90 can include a mixing vessel 100 into which can be fed the partially clarified wastewater 98 for specified and controlled agitation (e.g., with a mixing unit 101 such as an impeller 101) in order to activate auto-flocculation of suspended solids within the wastewater 98. In an example where there are no preliminary treatment operations 96, the raw wastewater 92 can be fed directly into the mixing vessel 100, where the specified agitation of the raw wastewater 92 can occur.

Similar to the system 60 of FIG. 3, in an example the system 90 can be operated to mix at least a portion 114 of secondary sludge or waste activated sludge 112 from a secondary treatment process 110 with the raw wastewater 92 or the partially clarified wastewater 98 to form a wastewater-sludge blend 116, which is subjected to the specified agitation in the mixing vessel 100 to promote auto-flocculation.

The mixing vessel 100 can be similar or identical to the mixing vessel 70 described above and can be any one of the example structures or vessels described above for the mixing vessel 70. For example, the mixing vessel 100 can be configured to agitate the raw wastewater 92, the partially clarified wastewater 98, or the wastewater-sludge blend 116 under a specified shear for a specified agitation period to provide an agitated wastewater 102. In an example, the mixing vessel 100 can be configured to provide the same specified agitation conditions (e.g., the same specified shear force, the same specified shear rate, and/or the same mixing speed) as is described above for the mixing vessel 70 in the system 60 of FIG. 3.

In an example, the agitated wastewater 102 can be passed from the mixing vessel 100 to a separate settling vessel 104 that is downstream of the mixing vessel 100. The specified sedimentation (e.g., allowing the agitated wastewater 102 to settle for a specified sedimentation period) is performed in the settling vessel 104. For example, the settling vessel 104 can be configured so that the agitated wastewater 102 will have a residence time in the settling vessel 104 that is similar or identical to the specified sedimentation period described above for the mixing vessel 70 of the system 60 of FIG. 3 (e.g., from about 1 min to about 30 minutes, for example from about 3 min to about 20 min, such as from about 5 min to about min). In other examples, the settling vessel 104 can be a conventional sedimentation tank, such as a clarifier similar to the primary clarifier 20, 40 in the systems 10 and 30 of FIGS. 1 and 2, in which case the residence time in the settling vessel 104 can be longer, such as from about 1 hour to about 3 hours. During the specified sedimentation period, the auto-flocs formed by auto-flocculation of the suspended particles in the agitated wastewater 102 (which was activated by the specified agitation of the raw wastewater 92, the partially clarified wastewater 98, or the wastewater-sludge blend 116) settle by gravity to the bottom of the settling vessel 104 where the auto-flocs can be removed as a settled sludge 106. In some examples, during the specified sedimentation period, there can be further auto-flocculation of suspended particles and thus formation of additional auto-flocs which can also settle during the specified sedimentation period. In an example, the settling vessel 104 is a basic tank where sedimentation of auto-flocculated suspended solids in the agitated wastewater 102 can settle. The settling vessel 104 could also be another more specialized vessel, such as a clarifier similar to the primary clarifier 20, 40.

The settled water 108 remaining after removal of the settled sludge 106 can be fed into the secondary treatment process 110, which produces the secondary sludge or waste activated sludge 112 that is separated from the treated effluent 94. While this secondary sludge 112 is conventionally removed as a waste sludge 118 after a secondary clarification (not shown in FIG. 4), in an example at least the portion 114 of the secondary sludge or waste activated sludge 112 is recycled back and mixed with the raw wastewater 92 or the partially clarified wastewater 98 to provide the wastewater-sludge blend 116 to enhance solids concentration and to promote auto-flocculation by the specified agitation conditions. The secondary treatment process 110 can be similar or identical to the secondary treatment processes 26, 46, and 80 described above with respect to FIGS. 1, 2, and 3 (e.g., the secondary treatment process 110 can be an activated sludge process, a WSP process, or an algae-based process for removal of additional organic matter that was not captured by the preliminary treatment operations 96 and/or the controlled agitation in the mixing vessel 100 and the specified sedimentation in the settling vessel 104).

In an example where at least the portion of the secondary sludge or waste activated sludge 114 is mixed with the raw wastewater 92 or the partially treated wastewater 98 to form the wastewater-sludge blend 116, which is subjected to the specified agitation in the mixing vessel 100, such as in the system 90 shown in FIG. 4, the TSS solids concentration of the wastewater-sludge blend 116 can be from about 250 mg/L to about 1500 mg/L. Further details are provided in the EXAMPLES below.

FIG. 5 is a schematic diagram of yet another example system 120 for the treatment of raw wastewater 122 to provide a treated effluent 124. The example system 120 is similar to the systems 60 and 90 of FIGS. 3 and 4, but with the addition of a primary clarifier before the specified agitation and sedimentation of the present disclosure. In an example, the system 120 includes one or more optional preliminary treatment operations 126 for initial separation of easier-to-separate solids from the raw wastewater 122 to provide a partially clarified wastewater 128. Similar to the conventional system 10 of FIG. 1, the system 120 can include a primary clarifier 130 into which is fed the partially clarified wastewater 128 and the primary clarifier 130 uses gravity settling to separate suspended solids as a primary sludge 132 from a settled water stream 134. In examples where there are no preliminary treatment operations 126, the raw wastewater 122 can be fed directly into the primary clarifier 130 such that the primary clarifier 130 separates the raw wastewater 122 into the primary sludge 132 and the settled water 134. The preliminary treatment operations 126 and the primary clarifier 130 can be similar or identical to the preliminary treatment operations 16 and the primary clarifier 20 described above with respect to the conventional system 10 of FIG. 1.

Downstream of the primary clarifier 130, the system 120 provides for the specified agitation and sedimentation described above with respect to FIGS. 3 and 4 that activates auto-flocculation of suspended solids within the settled water 134 to provide for enhanced removal of suspended solids that were not captured by the primary clarifier 130. In an example, the system 120 includes a mixing vessel 136 into which is fed the settled water 134 from the primary clarifier 130. The mixing vessel 136 can be similar or identical to the mixing vessels 70 and 100 described above with respect to the systems 60 and 90 of FIGS. 3 and 4. For example, the mixing vessel 136 can be configured to agitate the settled water 134, e.g., with a mixing unit 138 such as an impeller 138, under a specified shear (e.g., with one or more of a specified shear force, a specified shear rate, and/or a specified mixing speed) for a specified agitation period, followed by a specified sedimentation period, which can result in auto-flocculation of suspended particles in the settled water 134 that had not been settled or otherwise captured by the primary clarifier 130. In an example, the mixing vessel 136 can be configured to provide the same specified agitation conditions (e.g., the same specified shear force, the same specified shear rate, and/or the same mixing speed) as is described above for the mixing vessel 70 in the system 60 of FIG. 3 or the mixing vessel 100 in the system 90 of FIG. 4.

In the example shown in FIG. 5, sedimentation of the auto-flocculated particles in the agitated settled water 134 occurs in the same vessel in which the specified agitation conditions were applied to the settled water 134, i.e., within the mixing vessel 136. In such an example, the mixing unit 138 can be ceased and the aggregated particles that result from the auto-flocculation can be allowed to settle to the bottom of the mixing vessel 136 for the specified sedimentation period in the form of a sediment 140. The sediment 140 can be periodically removed from the mixing vessel 136 as a settled sludge 142, e.g., after one or more batches of the controlled agitation and sedimentation in the mixing vessel 136. In another example, not shown in FIG. 5, sedimentation of the agitated water 134 can be performed in a separate settling vessel similar or identical to the settling vessel 104 described above for the system 90 of FIG. 4. Whichever method of sedimentation is used, the specified sedimentation period of the agitated water 134 can be similar or identical to the specified sedimentation period described above for the mixing vessel 70 of FIG. 3 or the settling vessel 104 of FIG. 4 (e.g., from about 1 min to about 30 minutes, for example from about 3 min to about 20 min, such as from about 5 min to about 15 min).

After the sediment 140 has been allowed to settle to the bottom of the mixing vessel 136 or after sedimentation of a settled sludge in a separate settling vessel (not shown in FIG. 5), the remaining settled water 144 can be fed into a secondary treatment process 146, which produces a secondary sludge 148 that is separated from the treated effluent 124. The secondary treatment process 146 can be similar or identical to the secondary treatment processes 26, 46, 80, 110 described above with respect to FIGS. 1-4 (e.g., the secondary treatment process 146 can be an activated sludge process, a WSP process, or an algae-based process for removal of additional organic matter that was not captured by the preliminary treatment operations 126, the primary clarifier 130, and/or the controlled agitation and sedimentation of the mixing vessel 136). Although not shown in FIG. 5, the system 120 can include recycling back at least a portion of the secondary sludge 148 to be mixed with the raw wastewater 122, the partially clarified wastewater 128, or the settled water stream 134 to provide a wastewater-sludge blend (similar to the wastewater-sludge blends 86 and 116 described above with respect to the systems 60 and 90 of FIGS. 3 and 4).

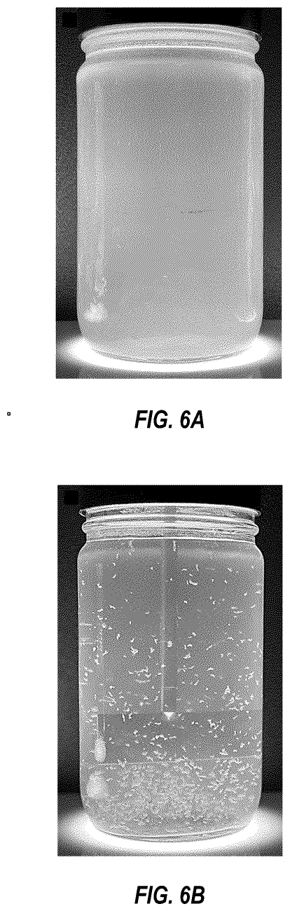

FIGS. 6A and 6B show photographs of two samples of wastewater that show the effect of the controlled agitation described in the present disclosure as compared to conventional preliminary treatment. FIG. 6A is a photograph of a sample of effluent from a primary clarifier (such as the settled water 22 effluent from the primary clarifier 20 in the conventional system 10 of FIG. 1). This primary effluent was allowed to settle in the vessel shown in FIG. 6A for two hours with no additional mixing. FIG. 6B is a photograph of a similar sample, but where the effluent from the primary clarifier was then mixed for 2 hours at 20 rpm (similar to the system 120 shown in FIG. 5 where a settled water 134 effluent from the primary clarifier 130 is then fed into the mixing vessel 136 for agitation by the impeller 138). The photograph in FIG. 6B was taken at the end of this mixing period while mixing was still being performed. As can be seen by a comparison of FIGS. 6A and 6B, the controlled mixing (FIG. 6B) resulted in the formation of numerous auto-flocs that are already beginning to settle to the bottom of the vessel. The water in the vessel in FIG. 6B is also visibly clearer than the effluent water in FIG. 6A, even when mixing is still being performed. In stark contrast, the effluent from the conventional primary treatment, e.g., after only settling the wastewater in a primary clarifier with no controlled agitation, is still very cloudy even after being allowed to settle for 2 hours.

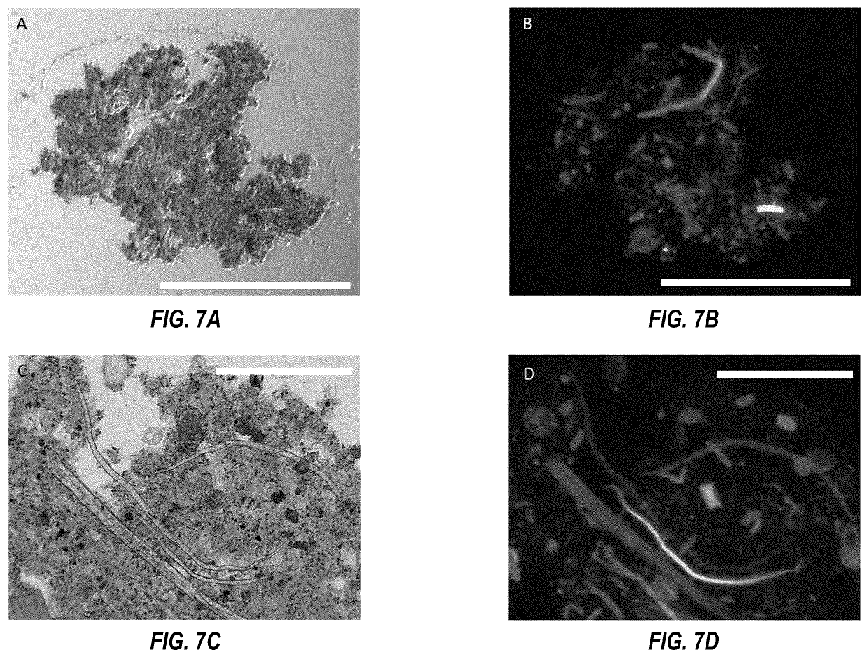

The inventors have also found that the controlled agitation of wastewater can result in better incorporation of micrometer-scale plastic structures (generally referred to as “microplastics”) into the auto-flocs such that the controlled agitation of the present disclosure is also better at removing microplastics from wastewater than conventional primary treatment methods such as the use of a primary clarifier alone. FIGS. 7A-7D show various micrographs of auto-flocs formed by the controlled agitation of the present disclosure. FIGS. 7A and 7C are bright-light microscopy images, while FIGS. 7B and 7D are autofluorescence microscopy images of the same auto-flocs as in FIGS. 7A and 7C, respectively, where the auto-flocs are viewed with 4′,6-diamidino-2-phenylindole (DAPI) autofluorescence microscopy. The scale bar in FIGS. 7A and 7B represent 1000 micrometers (μm), and the scale bar in FIGS. 7C and 7D represent 400 μm. In particular, FIGS. 7B and 7D show the incorporation of microplastics, where the blue autofluorescence of the image correspond with the present of microplastics.

In an example, the controlled agitation of the wastewater, e.g., of raw wastewater 62, 92, 122, partially clarified wastewater 68, 98, 128 after preliminary treatment 66, 96, 126, the wastewater-sludge blend 86, 116, or the settled water 134 after a primary clarifier 130, includes illuminating the wastewater 62, 68, 86, 92, 98, 116, 122, 128, 134 under a specified illuminance for a specified illumination period, which the inventors have found can further enhance auto-flocculation (and hence TSS separation).

The specified illuminance is selected to optimize microbe activity for improved auto-flocculation during the controlled agitation of the wastewater 62, 68, 86, 92, 98, 116, 122, 128, 134. In an example, the specified illuminance is from about 1 kilolux (kLux) to about 50 kLux, such as from about 3 kLux to about 30 kLux. In an example, the specified illuminance is selected to improve or optimize photopolymerization for improved auto-flocculation during the controlled agitation of the wastewater.

The specified illumination period is also selected to optimize microbe activity for improved auto-flocculation during the controlled agitation of the wastewater 62, 68, 86, 92, 98, 116, 122, 128, 134. In an example, the specified illumination period partially or totally overlaps the specified agitation period. In other words, the specified illumination period can be a portion of the specified agitation period or it can include the entirety of the specified agitation period. In an example, the specified illumination period is from about 1 min to about 5 hours, such as from about 5 min to about 3 hours, for example from about 30 min to about 2 hours. In an example, the specified illumination period occurs before the specified sedimentation period.

### EXAMPLES

Various embodiments of the present invention can be better understood by reference to the following EXAMPLES which is offered by way of illustration. The present invention is not limited to the EXAMPLES given herein.

### Comparative Example 1

A conventional wastewater treatment system similar to the system 10 of FIG. 1 was used for the preliminary treatment of the partially clarified wastewater (e.g., the partially clarified wastewater 18). The partially clarified wastewater had a total suspended solids (TSS) content of 218 mg/L. The partially clarified wastewater was fed into a clarifier (e.g., the primary clarifier 20) for initial separation of suspended solids. The partially clarified wastewater was allowed to settle in the clarifier for a total of about two (2) hours. After the 2 hours of sedimentation, effluent from the primary clarifier had a TSS content of about 65 mg/L. The effluent from the primary clarifier was sent to an activated sludge secondary treatment process (e.g., the secondary treatment process 26) for further treatment.

### Example 2

A one (1) liter (L) sample of the same partially clarified wastewater that was used in COMPARATIVE EXAMPLE 1 (e.g., with an initial TSS content of 218 mg/L) was placed in a 1 L mixing vessel with a mechanical impeller (e.g., similar to the mixing vessel 70 with the impeller 72 of FIG. 3, but without blending the partially clarified wastewater 68 with waste activated sludge 84). The 1 L sample of the partially clarified wastewater was mixed for twenty (20) minutes at a mixing speed of 20 rotations per minute (rpm). After 20 minutes, the mixing was ceased and the 1 L sample was left alone for 5 minutes. Suspended particles in the 1 L sample began spontaneously aggregating into flocs (also referred to herein as “auto-flocs”), which were allowed to settle for 5 minutes. After the 5 min settling time, the TSS content of the remaining water was measured and was found to be about 38 mg/L.

### Example 3

A second one (1) L sample of the same partially clarified wastewater as in COMPARATIVE EXAMPLE 1 and EXAMPLE 2 (e.g., with an initial TSS content of 218 mg/L) was placed into the same mixing vessel that was used in EXAMPLE 2 (e.g., similar to the mixing vessel 70 of FIG. 3, but without blending the partially clarified wastewater 68 with waste activated sludge 84). The 1 L sample of the partially clarified wastewater was mixed for 20 min at a mixing speed of 40 rpm. After the 20 min mixing time, the impeller was ceased and the 1 L sample was left alone for 5 minutes. Similar to EXAMPLE 2, suspended particles in the 1 L sample began to spontaneously auto-flocculate into auto-flocs, which were allowed to settle for 5 minutes. After the 5 min settling time, the TSS content of the remaining water was measured and was found to be about 30 mg/L.

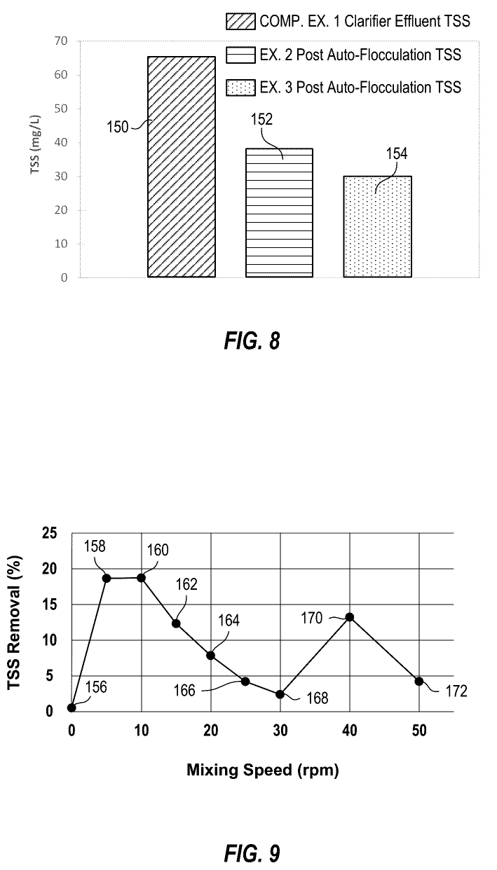

FIG. 8 is a graph showing the TSS values measured for the primary clarifier effluent of COMPARATIVE EXAMPLE 1 (data bar 150) and of the water post auto-flocculation for EXAMPLE 2 (data bar 152) and EXAMPLE 3 (data bar 154). As can be seen in FIG. 8, even a mixing time of as little as 20 minutes with a 5 minute settling time can substantially reduce the TSS content in wastewater, e.g., by as much as 50% or more, compared to conventional sedimentation, e.g., via a clarifier.

### Examples 4-11

Several samples of the same partially clarified wastewater as in COMPARATIVE EXAMPLE 1 (e.g., with an initial TSS content of 218 mg/L) were first subjected to a conventional sedimentation process (e.g., a primary clarifier similar to the primary clarifier 130 in FIG. 5) and then were placed in a mixing vessel with an impeller (e.g., similar to the mixing vessel 136 with the impeller 138 in FIG. 5). Each sample was subjected to mixing for 5 minutes followed by 5 minutes of settling time. The difference between the samples was the mixing speed of the impeller. Specifically, EXAMPLE 4 was mixed at 5 rpm; EXAMPLE 5 was mixed at 10 rpm; EXAMPLE 6 was mixed at 15 rpm; EXAMPLE 7 was mixed at 20 rpm; EXAMPLE 8 was mixed at 25 RPM; EXAMPLE 9 was mixed at 30 rpm; EXAMPLE 10 was mixed at 40 rpm; and EXAMPLE 11 was mixed at 50 rpm.

FIG. 9 is a graph showing the effect of the various mixing speeds for COMPARATIVE EXAMPLE 1 (e.g., conventional sedimentation in a primary clarifier with no additional agitation) (data point 156), and EXAMPLES 4-11 (conventional sedimentation in a clarifier followed by mixing at various mixing speeds for 5 minutes followed by 5 min settling) (data point 158 (EXAMPLE 4), data point 160 (EXAMPLE 5), data point 162 (EXAMPLE 6), data point 164 (EXAMPLE 7), data point 166 (EXAMPLE 8), data point 168 (EXAMPLE 9), data point 170 (EXAMPLE 10), and data point 172 (EXAMPLE 11)). The graph of FIG. 9 shows the percentage of TSS removal compared to the TSS in the effluent from the primary clarifier. As can be seen in FIG. 9, even a small amount of mixing time (only 5 minutes) followed by a short 5 min sedimentation could led to almost a 20% greater increase in TSS removal compared to only using conventional clarifier settling. In addition, the inventors found that if the mixing time is extended even further, the amount of TSS removal can be further increased, even essentially to 100% TSS removal. For example, when the primary effluent from the clarifier was mixed at 10 rpm for about 1.5 days (about 36 hours), it resulted in approximately 100% TSS removal from the clarifier effluent.

### Examples 12-19

Several samples of the same partially clarified wastewater as in COMPARATIVE EXAMPLE 1 (e.g., with an initial TSS content of 218 mg/L) were placed in a mixing vessel with an impeller (e.g., similar to the mixing vessel 70 with the impeller 72 in FIG. 3). A control sample with no mixing and only a 5 min settling time for the partially clarified wastewater was also included for comparison (similar to COMPARATIVE EXAMPLE 1). Each of the samples of EXAMPLES 12-19 were subjected to mixing for 5 minutes followed by 5 minutes of settling time, with the difference between EXAMPLES being the mixing speed of the impeller. Specifically, EXAMPLE 12 was mixed at 5 rpm; EXAMPLE 13 was mixed at 10 rpm; EXAMPLE 14 was mixed at 15 rpm; EXAMPLE 15 was mixed at 20 rpm; EXAMPLE 16 was mixed at 25 RPM; EXAMPLE 17 was mixed at 30 rpm; EXAMPLE 18 was mixed at 40 rpm; and EXAMPLE 19 was mixed at 50 rpm.

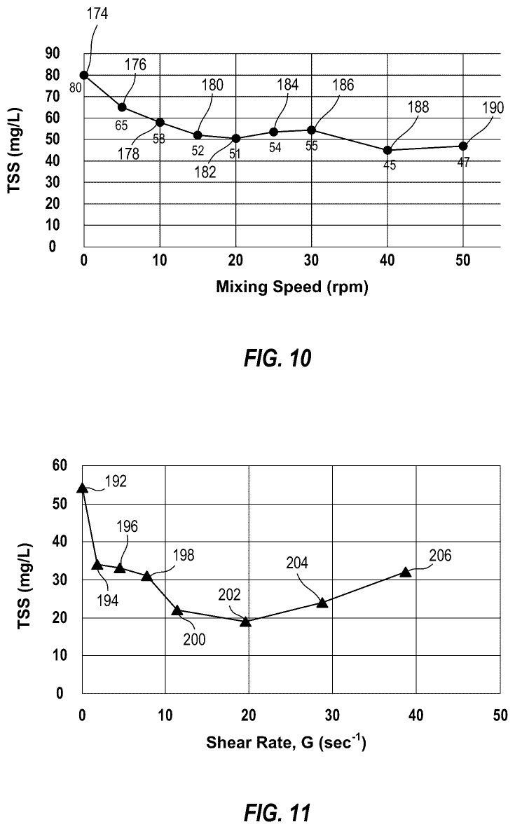

FIG. 10 is a graph showing the effect of the various mixing speeds on the TSS content of the partially clarified wastewater after no mixing (COMPARATIVE EXAMPLE 1) (data point 174), and at various mixing speeds for 5 minutes followed by 5 minutes of settling time (data point 176 (EXAMPLE 12), data point 178 (EXAMPLE 13), data point 180 (EXAMPLE 14), data point 182 (EXAMPLE 15), data point 184 (EXAMPLE 16), data point 186 (EXAMPLE 17), data point 188 (EXAMPLE 18), and data point 190 (EXAMPLE 12)). As can be seen in FIG. 10, for a high-solids laden raw wastewater, slightly faster mixing (e.g., at 40 rpm) for as little as five minutes (EXAMPLE 18, data point 188) can substantially increase TSS removal compared to the unmixed partially clarified wastewater (COMPARATIVE EXAMPLE 1, data point 174).

### Comparative Example 20

A conventional wastewater treatment system similar to the system 30 of FIG. 2 was used for the primary treatment of the partially clarified wastewater (e.g., the partially clarified wastewater 38). As shown in FIG. 2, the partially clarified wastewater was blended with a waste activated sludge (e.g., the waste activated sludge 48) to form a wastewater-sludge blend (e.g., the blend 50). The partially clarified wastewater had a TSS content of 228 mg/L whereas the waste activated sludge had a TSS content of 2690 mg/L. The wastewater-sludge blend was fed into a clarifier (e.g., the primary clarifier 40) for initial separation of suspended solids. The wastewater-sludge blend was allowed to settle in the clarifier for a total of about 30 minutes. After the 30 minutes of sedimentation, effluent from the primary clarifier (e.g., the settled water 42) had a TSS content of about 54 mg/L. The effluent from the primary clarifier was sent to an activated sludge secondary treatment process (e.g., the secondary treatment process 46) for further treatment.

### Examples 21-27

Several one (1) liter (L) samples comprising 0.85 L of the same partially clarified wastewater that was used in COMPARATIVE EXAMPLE 20 (e.g., with an initial TSS content of 228 mg/L) and 0.15 L of the same waste activated sludge that was used in COMPARATIVE EXAMPLE 20 (e.g., with an initial TSS content of 2690 mg/L) were prepared to form a wastewater-sludge blend (e.g., wastewater-sludge blend 86). The resulting TSS content of the wastewater-sludge blend was 597 mg/L. The 1 L samples of the wastewater-sludge blend were each placed in a 1 L mixing vessel with a mechanical impeller (e.g., similar to the mixing vessel 70 with the impeller 72 of FIG. 3) and were agitated for thirty (30) seconds and then allowed to settle for 30 minutes. The difference between the samples was the shear rate used during agitation. Specifically, EXAMPLE 21 was mixed at a shear rate of 1.8 s⁻¹, EXAMPLE 22 was mixed at a shear rate of 4.5 s⁻¹, EXAMPLE 23 was mixed at a shear rate of 7.7 s⁻¹, EXAMPLE 24 was mixed at a shear rate of 11.3 s⁻¹, EXAMPLE 25 was mixed at a shear rate of 19.5 s⁻¹, EXAMPLE 26 was mixed at a shear rate of 28.7 s⁻¹, and EXAMPLE 27 was mixed at a shear rate of 38.7 s⁻¹.

FIG. 11 is a graph showing the effect of shear rate on the TSS content in the settled water. The data are shown for the settled water in control (COMPARATIVE EXAMPLE 20, data point 192, e.g., the settled water 42 in system 30 of FIG. 2.) and the settled water after agitation at various shear rates for 30 seconds followed by 30 minutes of settling time (e.g., the settled water 76 in system 60 of FIG. 3) (data point 194 (EXAMPLE 21), data point 196 (EXAMPLE 22), data point 198 (EXAMPLE 23), data point 200 (EXAMPLE 24), data point 202 (EXAMPLE 25), data point 204 (EXAMPLE 26), and data point 206 (EXAMPLE 27)). As can be seen in FIG. 11, just blending partially clarified wastewater and waste activated sludge without shear rate incorporated (COMPARATIVE EXAMPLE 20, data point 192) left significantly more TSS in the settled water compared to applying a shear rate of agitation (EXAMPLES 21-27), which indicates that auto-flocculation can occur when certain agitation conditions are applied, even when wastewater is blended with waste activated sludge.

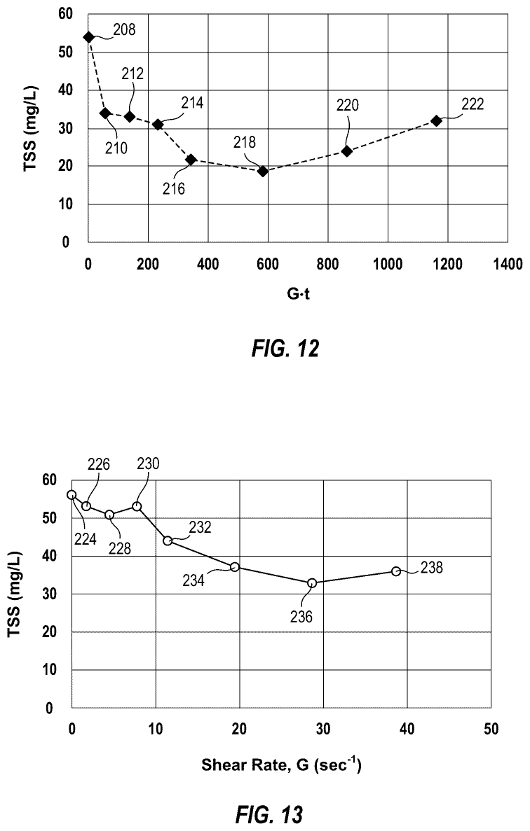

FIG. 12 is a graph showing the effect of the product of shear rate (G) and agitation period (t), Gt, on the TSS content in the settled water. The data are shown for the settled water in control (COMPARATIVE EXAMPLE 20, data point 192, e.g., the settled water 42 in system 30 of FIG. 2.) and the settled water after agitation at various shear rates for seconds followed by 30 minutes of settling time (e.g., the settled water 76 in system 60 of FIG. 3) (data point 210 (EXAMPLE 21), data point 212 (EXAMPLE 22), data point 214 (EXAMPLE 23), data point 216 (EXAMPLE 24), data point 218 (EXAMPLE 25), data point 220 (EXAMPLE 26), and data point 222 (EXAMPLE 27)).

### Comparative Example 28

A conventional wastewater treatment system similar to the system 30 of FIG. 2 was used for the primary treatment of partially clarified wastewater (e.g., the partially clarified wastewater 38) that had been blended with waste activated sludge (e.g., waste activated sludge 48) to form a wastewater-sludge blend (e.g., the wastewater sludge blend 50). The partially clarified wastewater had a TSS content of 203 mg/L and the waste activated sludge had TSS of 3625 mg/L. The wastewater-sludge blend was fed into a clarifier (e.g., the primary clarifier 40) for initial separation of suspended solids. The wastewater-sludge blend was allowed to settle in the clarifier for a total of about 30 minutes. After the 30 minutes of sedimentation, effluent from the primary clarifier had a TSS content of about 56 mg/L. The effluent from the primary clarifier was sent to an activated sludge secondary treatment process for further treatment.

### Examples 29-35

Several one (1) liter (L) samples comprising 0.99 L of the same partially clarified wastewater that was used in COMPARATIVE EXAMPLE 28 (e.g., with an initial TSS content of 203 mg/L) and 0.01 L of the same waste activated sludge that was used in COMPARATIVE EXAMPLE 28 (e.g., with an initial TSS content of 3625 mg/L) were prepared to form samples of a wastewater-sludge blend (e.g., the waste activated blend 86). Each wastewater-sludge blend sample was placed in a 1 L mixing vessel with a mechanical impeller (e.g., similar to the mixing vessel 70 with the impeller 72 of FIG. 3). The resulting TSS of the wastewater-sludge blend was 237 mg/L. The 1 L blend samples were each agitated for sixty (60) seconds and then allowed to settle for 30 minutes. The difference between the samples was the shear rate used in the specified agitation conditions. Specifically, EXAMPLE 29 was mixed at a shear rate of 1.8 s⁻¹, EXAMPLE 30 was mixed at a shear rate of 4.5 s⁻¹, EXAMPLE 31 was mixed at a shear rate of 7.7 s⁻¹, EXAMPLE 32 was mixed at a shear rate of 11.3 s⁻¹, EXAMPLE 33 was mixed at a shear rate of 19.5 s⁻¹, EXAMPLE 34 was mixed at a shear rate of 28.7 s⁻¹, and EXAMPLE 35 was mixed at a shear rate of 38.7 s⁻¹.

FIG. 13 is a graph showing the effect of shear rates on the TSS content in the settled water. The data are shown for the settled water in control (COMPARATIVE EXAMPLE 28, data point 224, e.g., the settled water 42 in system 30 of FIG. 2.) and the settled water after agitation at various shear rates for 60 seconds of mixing followed by 30 minute settling (data point 226 (EXAMPLE 29), data point 228 (EXAMPLE 30), data point 230 (EXAMPLE 31), data point 232 (EXAMPLE 32), data point 234 (EXAMPLE 33), data point 236 (EXAMPLE 34), and data point 238 (EXAMPLE 35)). As can be seen in FIG. 13, just blending partially clarified wastewater and waste activated sludge without shear rate incorporated (COMPARATIVE EXAMPLE 28, data point 224) left significantly more TSS in the settled water compared to EXAMPLES 29-35 (data points 228-238), which again indicates that auto-flocculation can be induced under specified agitation conditions even when wastewater is blended with waste activated sludge.

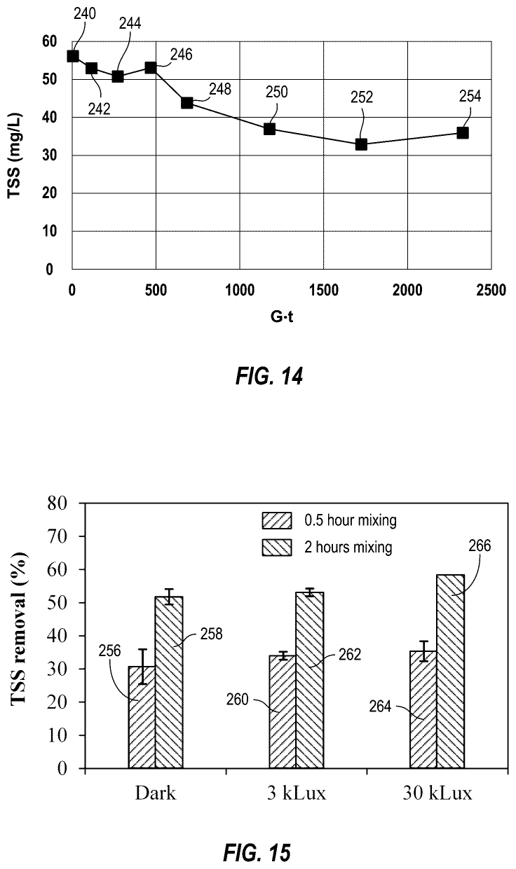

FIG. 14 is a graph showing the effect of the product of shear rate (G) and agitation period (t), Gt, on the TSS content in the settled water. The data are shown for the settled water in control (COMPARATIVE EXAMPLE 28, data point 240) and the settled water after agitation at various shear rates for 60 seconds of mixing followed by 30 minute settling (data point 242 (EXAMPLE 29), data point 244 (EXAMPLE 30), data point 246 (EXAMPLE 31), data point 248 (EXAMPLE 32), data point 250 (EXAMPLE 33), data point 252 (EXAMPLE 34), and data point 254 (EXAMPLE 35)).

### Examples 36-41

The same partially clarified wastewater as in COMPARATIVE EXAMPLE 1 (e.g., with an initial TSS content of 218 mg/L) was first treated in a primary clarifier (e.g., the primary clarifier 20 in the system 10 of FIG. 1), and various samples of the effluent from the primary clarifier were placed in a mixing vessel with an impeller (e.g., similar to the mixing vessel 136 with the impeller 138 in FIG. 5). Each sample was mixed in the mixing vessel at a mixing speed of 20 rpm for one of two different mixing times (either 0.5 hour mixing or 2 hour mixing) and under one of three illumination conditions while the mixing occurred (either in full darkness, with an illuminance of 3 kLux, or with an illuminance of 30 kLux). Specifically, EXAMPLE 36 was mixed for 0.5 hours in darkness; EXAMPLE 37 was mixed for 2 hours in darkness; EXAMPLE 38 was mixed for 0.5 hours with an illuminance of 3 kLux; EXAMPLE 39 was mixed for 2 hours with an illuminance of 3 kLux; EXAMPLE 40 was mixed for 0.5 hours with an illuminance of 30 kLux; and EXAMPLE 41 was mixed for 2 hours with an illuminance of 30 kLux.

FIG. 15 is a graph of the percentage of TSS removal compared to the TSS content of the effluent from the primary clarifier for each of the different illumination conditions and mixing times. As shown in FIG. 15, illumination of the wastewater during the controlled agitation can further enhance auto-flocculation and TSS removal, with both the 3 kLux illuminance (EXAMPLES 38 (data bar 260) and 39 (data bar 262)) and the 30 kLux illuminance (EXAMPLES 40 (data bar 264) and 41 (data bar 266)) resulting in an increase in TSS removal compared to the samples that were mixed in darkness (EXAMPLES 36 (data bar 256) and 37 (data bar 258)).

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for treatment of wastewater, comprising the steps of:
receiving a wastewater containing solid particles in suspension;
agitating the wastewater for a specified agitation period under specified agitation conditions sufficient to enable auto-flocculation of at least a portion of the solid particles into flocs to provide an agitated wastewater;
allowing the agitated wastewater to settle for a specified sedimentation period to allow at least a portion of the flocs to settle; and
separating at least a portion of the settled flocs from the agitated wastewater to provide a clarified wastewater effluent.

2. A method according to claim 1, wherein the specified agitation conditions comprise at least one of a specified shear force, a specified shear rate, or a specified mixing speed.

3. A method according to claim 2, wherein the specified shear force is from about Newtons per square meter to about 0.05 Newtons per square meter.

4. A method according to claim 2, wherein the specified shear rate is from about 0.5 reciprocal seconds to about 50 reciprocal seconds.

5. A method according to claim 2, wherein the specified mixing speed is from about 5 rotations per minute to about 100 rotations per minute.

6. A method according to claim 1, wherein the specified agitation period is from about second to about 120 minutes.

7. A method according to claim 1, wherein the specified sedimentation period is from about 1 minute to about 30 minutes.

8. A method according to claim 1, wherein the wastewater comprises a raw wastewater, a partially-clarified wastewater, or a blend of wastewater and waste activated sludge.

9. A method according to claim 1, wherein the wastewater has a total suspended solids content of from about 200 mg/L to about 1500 mg/L.

10. A method according to any one of claim 1, wherein the wastewater comprises an effluent from a clarifier in a wastewater treatment process.

11. A method according to claim 1, further comprising treating the clarified wastewater effluent in a secondary treatment process.

12. A method according to claim 11, wherein the secondary treatment process comprises an activated sludge process, a waste stabilization pond process, or an algae-based process.

13. A method according to claim 1, further comprising illuminating the wastewater with light having specified illumination conditions simultaneously or substantially simultaneously with the agitating of the wastewater under the specified agitation conditions.

14. A method according to claim 13, wherein the light has an illuminance of from about 1 kilolux to about 50 kilolux.

15. A system for treatment of wastewater, the system comprising:
a mixing vessel configured to receive a wastewater containing solid particles in suspension and to agitate the wastewater for a specified agitation period under specified agitation conditions sufficient to enable auto-flocculation of at least a portion of the solid particles into flocs to provide an agitated wastewater;
a settling vessel configured to allow the agitated wastewater to settle for a specified sedimentation period to allow at least a portion of the flocs to settle to a bottom of the settling vessel; and
a separating device or structure configured to separate at least a portion of the settled flocs from the agitated wastewater to provide a clarified wastewater effluent.

16. A system according to claim 15, wherein the mixing vessel and the settling vessel are the same vessel.

17. A system according to claim 15, wherein the mixing vessel and the settling vessel are separate vessels.

18. A system according to claim 15, wherein the wastewater comprises a raw wastewater, a partially-clarified wastewater, or a blend of wastewater and a waste activated sludge.

19. A system according to claim 15, wherein the wastewater has a total suspended solids content of from about 200 mg/L to about 1500 mg/L.

20. A system according to claim 15, further comprising a primary clarifier, wherein the wastewater comprises an effluent from the primary clarifier.

21. A system according to claim 15, further comprising a secondary treatment process to further treat the clarified wastewater effluent.

22. A system according to claim 21, wherein the secondary treatment process comprises an activated sludge process, a waste stabilization pond process, or an algae-based process.

23. A system according to claim 15, further comprising an illumination device configured to illuminate the wastewater within the mixing vessel with light having specified illumination conditions simultaneously or substantially simultaneously with the agitating of the wastewater under the specified agitation conditions.

24. A system according to claim 23, wherein the light has an illuminance of from about 1 kilolux to about 50 kilolux.
